(19) United States
(12) Patent Application Publication
(10) Pub. No.: US 2004/0131212 A1
(43) Pub. Date: Jul. 8, 2004

(54) LCD display with an infrared transmission interface for transmitting audio signals in stereo

(76) Inventor: Steven Chang, Chung Ho City (TW)

Correspondence Address: VENABLE, BAETJER, HOWARD AND CIVILETTI, LLP, P.O. BOX 34385, WASHINGTON, DC, 20043-9998, US

(21) Appl. No.: 10/367,741

(22) Filed: Feb. 19, 2003

(30) Foreign Application Priority Data
Jan. 7, 2003 (TW) 092200213

(51) Int. Cl. H04R 5/00; H04B 3/00; H04R 5/02

(52) U.S. Cl. 381/311; 381/306; 381/1; 381/80

(57) ABSTRACT

An LCD display has a built-in audio processing device. The audio processing device receives audio signals from a piece of Audio/Video equipment and modulates the received audio signals. The modulated audio signals are further wirelessly emitted by infrared emitting diodes that are mounted in a position near the screen of the LCD display. When a user wears wireless earphones, the audio signals can be received and played by the earphones so people in the proximity of the LCD display will not be distracted by the sound.

### BACKGROUND OF THE INVENTION

1. Field of the Invention

The present invention relates to an LCD display with an infrared transmission interface, and more particularly to an LCD display capable of simultaneously processing video and audio signals and transmitting the audio signals in stereo through the infrared transmission interface.

2. Description of Related Art

People shopping for vehicles are interested in the performance of the vehicle and installed equipment. For example, liquid crystal display (LCD) devices have become popular and common in vehicles in recent years. Depending on the device with which the LCD display is used, the ideal position in the vehicle for the LCD display may vary. For example, the ideal position for an LCD GPS (global positioning system) display may be in the dashboard. In another application, the ideal position of the LCD display may be on the ceiling near the inside courtesy light, wherein the LCD device functions as a television that shows programs for backseat passengers. Therefore, the LCD display would not distract the driver.

However, since the audio signals of the programs are broadcast over the vehicle audio system, the sound will still distract the driver.

To overcome the shortcomings, the present invention provides an LCD display with a stereo transmission interface to mitigate or obviate the aforementioned problems.

### SUMMARY OF THE INVENTION

The primary objective of the present invention is to provide an LCD display with an infrared transmission interface, wherein audio signals are capable of being wirelessly transmitted in stereo by means of infrared.

People who watch programs on the LCD display in accordance with the present invention can use a pair of earphones that receive infrared signals and listen to the emitted audio signals. Use of the earphones prevents the sound from distracting other people.

To achieve the objective of the present invention, an audio processing device is installed in the LCD display. Said audio processing device has an audio input port, a modulating unit and a transmitting unit. The audio input port connects to an audio source, such as an audio output terminal of a piece of video equipment. The modulating unit is connected to the audio input port to modulate audio signals from the audio input port. The transmitting unit is composed of multiple signal emitting elements each being connected to the modulating unit to receive the modulated audio signals and then to emit the audio signals wirelessly.

The transmitting unit is mounted near the screen of the LCD display, and the modulated audio signals are output from the transmitting unit.

The audio processing device further includes an automatic gain controller (AGC) connected between the audio input port and the modulating unit to control the volume of the audio signals.

The audio signals are in stereo and have two parts. The transmitting unit is composed of multiple infrared emitting diodes that are divided into two groups to respectively emit the two parts with one part corresponding to the left earphone and the other to the right earphone.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an LCD display in accordance with the present invention;

FIG. 2 is a cross sectional view of a part of the LCD display in FIG. 1;

FIG. 3 is a circuit diagram of an audio processing device mounted in the LCD display in FIG. 1;

FIG. 4 is an operational perspective view of the LCD display in FIG. 1 installed inside a car; and

FIG. 5 is an operational perspective view of the LCD display in FIG. 1 used with a computer.

### DETAIL DESCRIPTION OF THE INVENTION

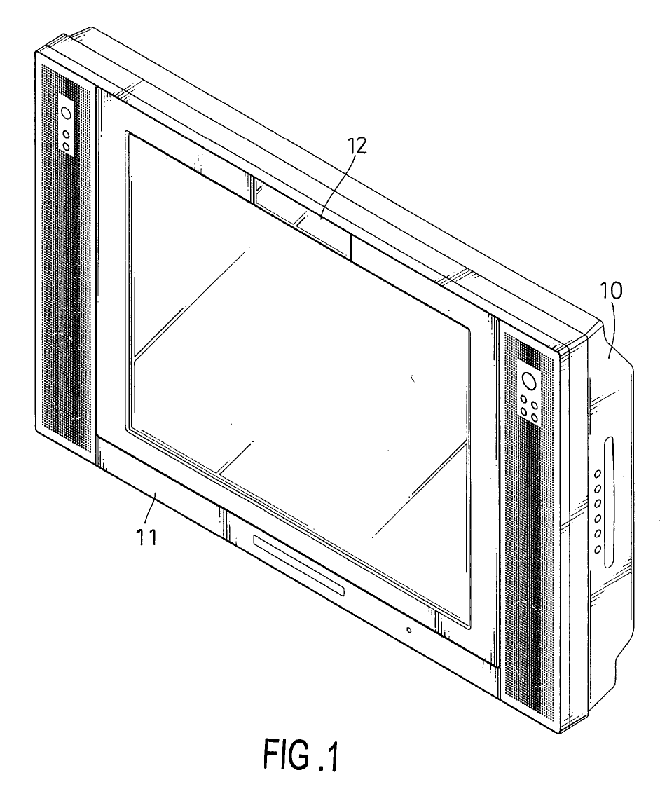

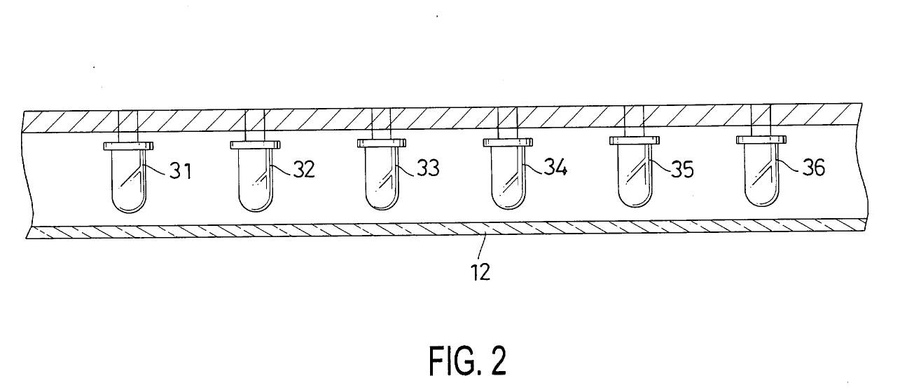

With reference to FIGS. 1 and 2, an LCD (liquid crystal display) display device (10) in accordance with the present invention has a screen and a frame (11). The screen has a front. The frame (11) is mounted around the screen. A signal emitting chamber (12) is defined in the frame (11) to hold an audio processing device. With reference to FIG. 2, the audio processing device has multiple infrared emitting diodes (31-36) that are mounted inside the signal emitting chamber (12) to emit modulated audio signals.

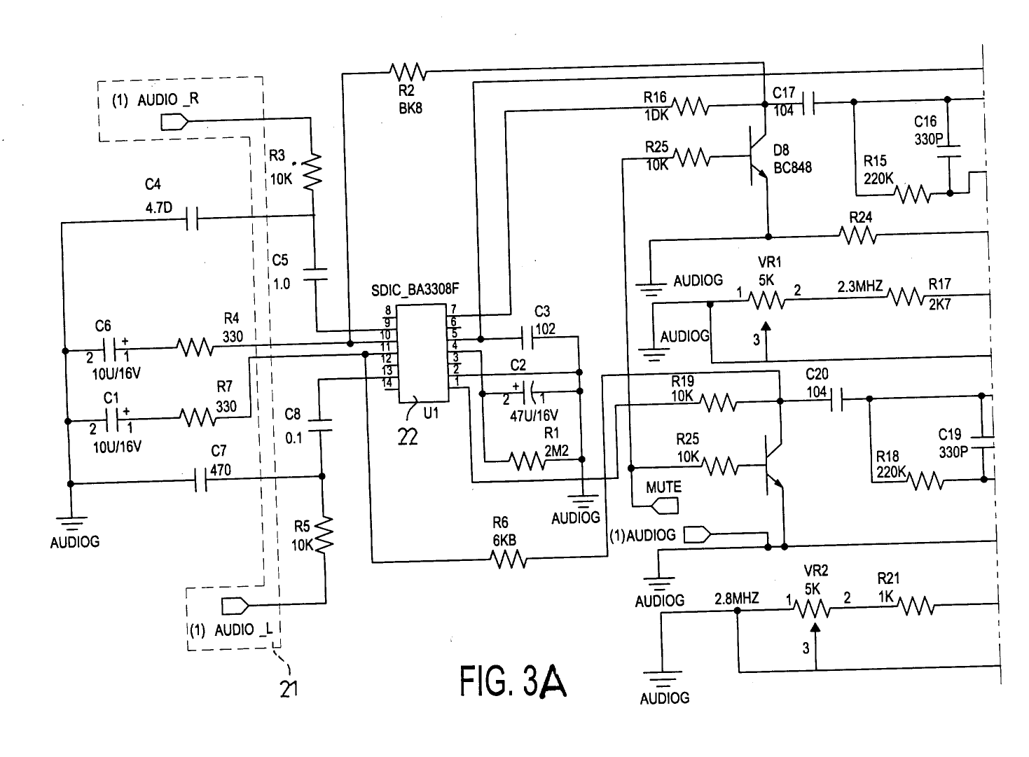

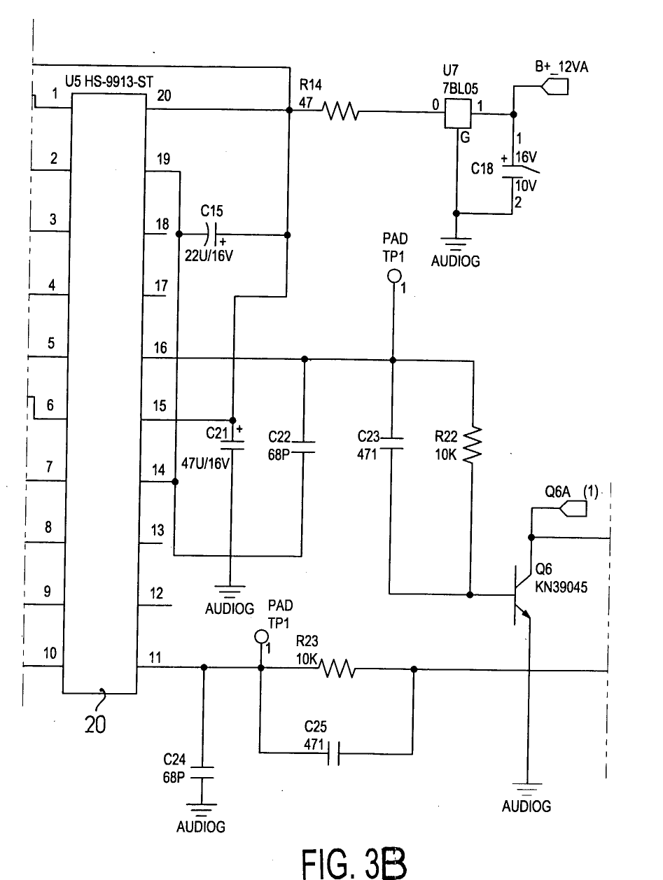

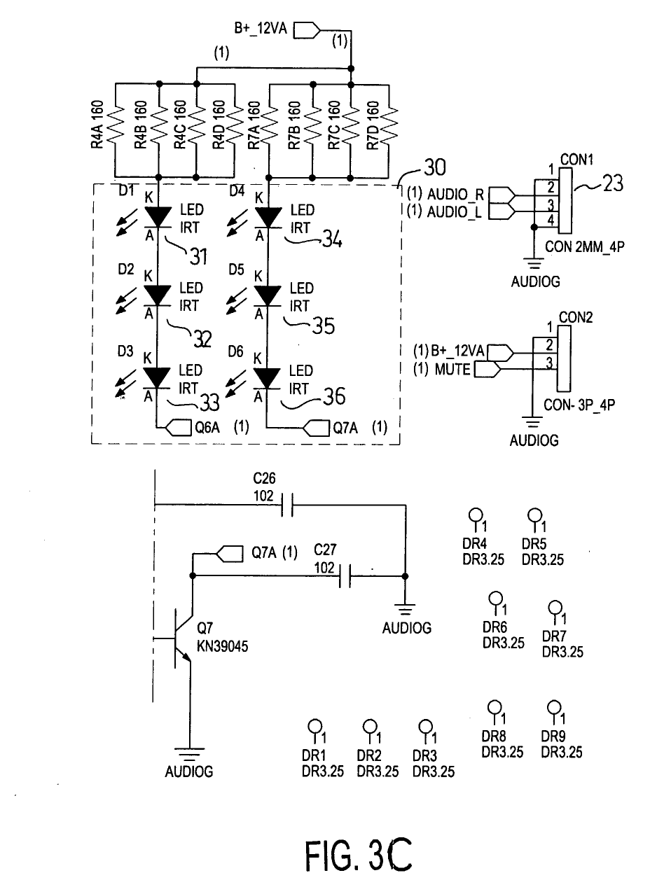

With further reference to FIG. 3, the audio processing device comprises an audio input port (21), an automatic gain controller (AGC) (22), a modulating unit (20), a transmitting unit (30) and an earphone jack (23).

The audio input port (21) is adapted to connect to an external audio source. For example, the audio input port (21) is able to connect to two audio output terminals (Audio_R and Audio_L) of any audio/video equipment to receive audio signals. The audio signals from the output terminals (Audio_R and Audio_L) are stereo signals.

The AGC (22) is connected between the audio input port (21) and the modulating unit (20) and automatically controls the gain applied to the input audio signals from the audio input port (21).

The modulating unit (20) modulates the audio signals output from the AGC (22) and then outputs the modulated audio signals to the transmitting unit (30).

The transmitting unit (30) is made up of infrared emitting diodes (31-36. The six infrared emitting diodes (31-36) are divided into two groups. Each group emits a separate modulated stereo audio signal.

The earphone jack (23) is connected to the audio input port (21) so the audio signals can be transmitted through an audio wire (not shown) to the earphones.

In the embodiment, the stereo audio signals are input to the terminals (AUDIO_R and AUDIO_L) of the audio input port (21) then processed by the AGC (22) to obtain a proper gain. The processed audio signals are modulated by the modulating unit (20) and then output to the transmitting unit (30). The two groups of the infrared emitting diodes (31-33, 34-36) respectively output the modulated audio signals. Therefore, the viewer is able to listen to the audio signals by using a pair of the wireless earphones.

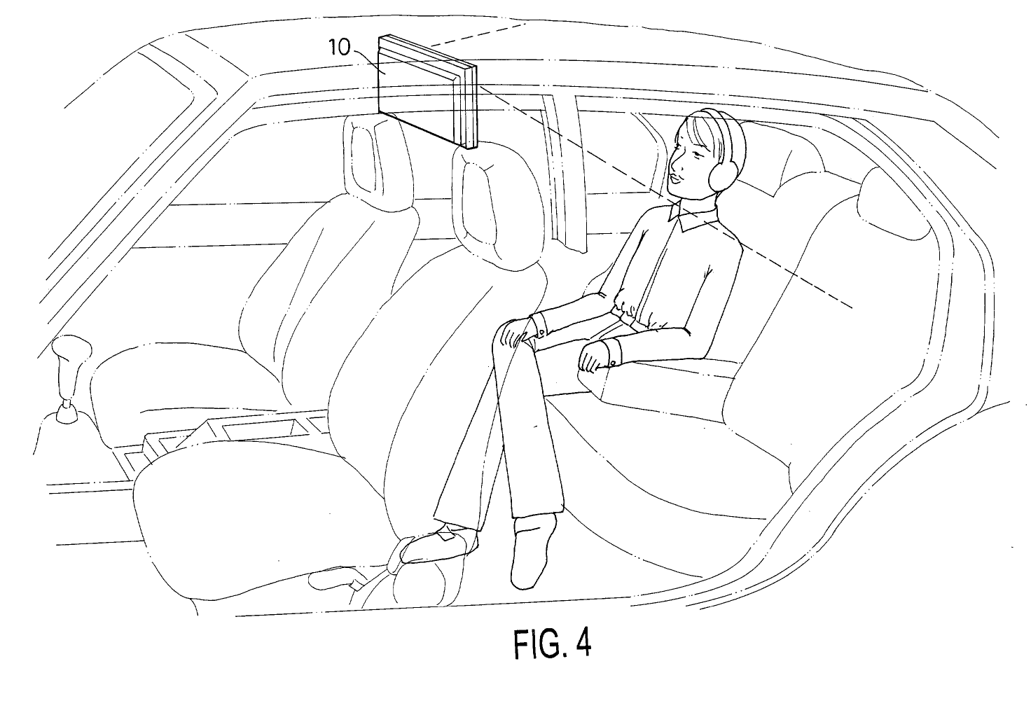

With reference to FIG. 4, the LCD display device (10) can be installed inside a car so the backseat passenger can watch the program shown on the LCD display device (10). Simultaneously, the audio signals of the programs are emitted from the LCD display device (10) and received by the wireless earphones (not numbered) that are worn by the passenger. Therefore, the driver will not be distracted by either the image or the audio of the programs.

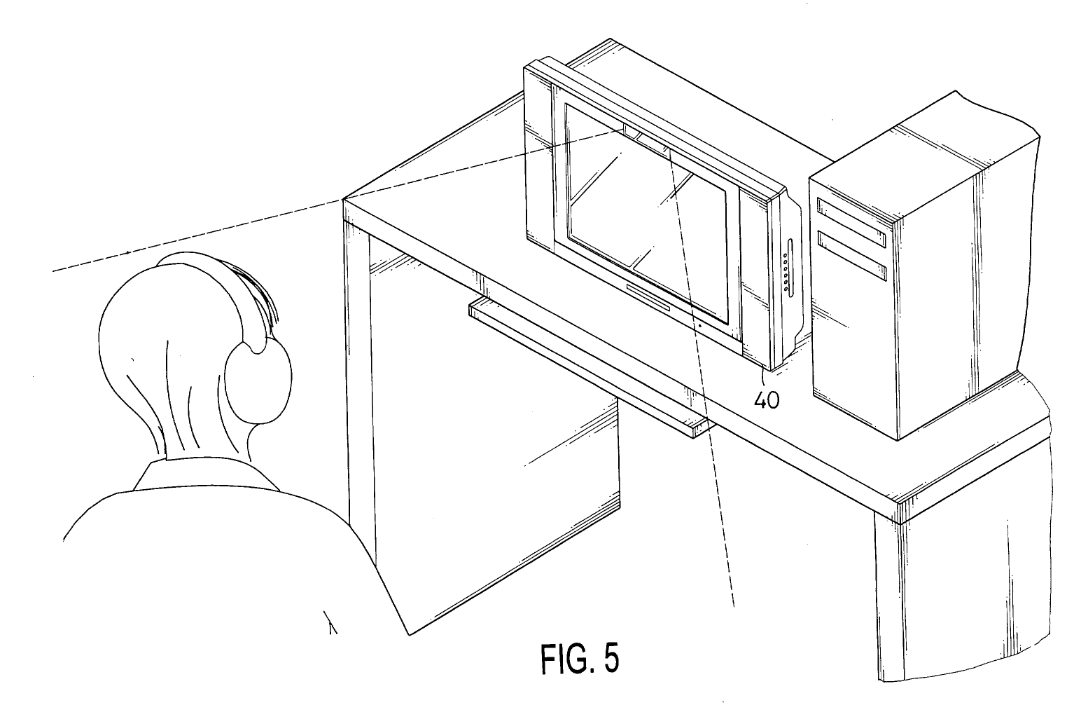

With reference to FIG. 5, the LCD display device (10) is used as a monitor for a computer. When a person using the computer plays the games or films with the LCD display device (10), the person can wear wireless earphones to receive and listen to the music or audio track.

The LCD display device (10) also allows a person to listen to the audio with hardwired earphones by inserting the earphone plug into the earphone jack (23) of the LCD display device (10).

The LCD display device (10) in accordance with the present invention has the following advantages.

1. The present invention has built-in infrared transmission elements to emit stereo audio signals. Therefore, the consumer can directly listen to the audio by using wireless earphones without having to purchase any additional audio processing equipment.

2. Whether the LCD display can be used in vehicles or with personal computers, and the audio will not distract the driver and other people in close proximity to the LCD display.

3. A person can choose whether to use wireless or hardwired earphones to receive the audio signals.

Even though numerous characteristics and advantages of the present invention have been set forth in the foregoing description together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LCD display with an infrared transmission interface for transmitting audio signals in stereo, the LCD display comprising a screen and a frame in which a signal emitting chamber is defined to hold an audio processing unit that comprises:
an audio input port adapted to connect to an audio source to receive audio signals;
a modulating unit connected to the audio input port to modulate the received audio signals; and
a transmitting unit composed of multiple infrared emitting diodes each being mounted inside the signal emitting chamber and connected to the modulating unit, to emit modulated audio signals output from modulating unit.

2. The LCD display as claimed in claim 1, wherein the audio processing device further comprises an automatic gain controller (AGC) connected between the audio input port and the modulating unit to adjust gain of the received audio signals.

3. The LCD display as claimed in claim 1, wherein the received audio signals are in two parts, and the multiple infrared emitting diodes are divided into two groups that respectively emit the two parts of the audio signals.

4. The LCD display as claimed in claim 1, wherein the audio processing device further comprising an earphone jack connected to the audio input port, wherein the earphone jack is adapted to receive an earphone plug.

5. The LCD display as claimed in claim 2, wherein the audio processing device further comprises an earphone jack connected to the audio input port, wherein the earphone jack is adapted to receive an earphone plug.

6. The LCD display as claimed in claim 3, wherein the audio processing device further comprising an earphone jack connected to the audio input port, wherein the earphone jack is adapted to receive an earphone plug.
